(19) United States
(12) Patent Application Publication
(10) Pub. No.: US 2013/0164442 A1
(43) Pub. Date: Jun. 27, 2013

(54) MOLD FOR NANOIMPRINT LITHOGRAPHY

(71) Applicant: Commissariat A L'Energie Atomique Et Aux Energies Alternatives, Paris (FR)

(72) Inventors: Stephan LANDIS, Voiron (FR); Berangere Hyot, Eybens (FR)

(73) Assignee: Commissariat A L'Energie Atomique Et Aux Energies Alternatives, Paris (FR)

(21) Appl. No.: 13/712,211

(22) Filed: Dec. 12, 2012

(30) Foreign Application Priority Data
Dec. 12, 2011 (FR) 11 61464

(51) Int. Cl. B29C 59/02

(52) U.S. Cl. CPC B29C 59/02
USPC 427/133; 264/219; 425/385; 264/482

(57) ABSTRACT

The present invention relates to a method for manufacturing a nanoimprint lithography mold. The method comprises an initial step of depositing, on a mechanical support, a layer of a phase-changing material having a volume variation of at least 2% between a crystalline phase and an amorphous phase. The method is characterized in that it also comprises a step of personalization of the mold, achieved by making the layer of phase-changing material transition locally from its crystalline phase to its amorphous phase in order to form relief patterns therein.

The invention comprises such a mold as well as a method for modifying such a mold.

### TECHNICAL FIELD OF THE INVENTION

The present invention relates in general to the nanoimprint lithography used by the micro and nanotechnologies industry. It relates more particularly to a method for producing a nanometric imprint mold that can be easily adjusted, corrected and even reconfigured.

### PRIOR ART

The micro and nanotechnologies industry relies on lithography during numerous steps of manufacture of the devices that it produces, in order to define shapes and sizes of patterns created in the different layers of materials constituting these devices.

To attain the nanometric dimensions required to maintain the ever-increasing integration of an increasingly larger number of components in a given device, the micro and nanotechnologies industry must now resort to techniques that go beyond the traditional optical lithography based, ever since its advent in the nineteen sixties, on the use of masks used to expose photosensitive resins, in which the patterns to be engraved are reproduced, to light in the visible wavelength region. In particular, to limit diffraction of the light through masks, shorter wavelengths are now used: ultraviolet and far ultraviolet, and even x-rays, as are complex techniques such as, for example, immersion lithography, which demand considerable investments for their development and their industrial employment.

A known technique, which does not necessitate the use of masks and which effectively makes it possible to define the patterns with resolution compatible with the desired integration levels, in other words several hundreds or several tens of nanometers (nm=10⁻⁹ meter) at present, uses an electron beam to imprint the resin. However, this is intrinsically a slow technique, since each of the patterns constituting the device to be manufactured then has to be written sequentially in each manufacturing step. Considering that the densest integrated circuits now contain billions of transistors, and therefore at least as many patterns, the sequential imprinting of each of the patterns is incompatible with industrial production. In fact, electron-beam lithography is most often reserved for manufacture of masks themselves or for manufacture of experimental circuits in the laboratory.

In the mid nineteen nineties, a very different optical lithography technique, which makes it possible in particular to become completely free of the aforesaid diffraction problems, was invented by Professor Stephen Y. CHOU. The principle of that technique, known as “nanoimprint lithography”, was disclosed in several publications, especially that entitled “Nanoimprint Lithography” in the “Journal of Vacuum Science and Technology”, reference B 14(6), November/December, 1996. From that time on, nanoimprint lithography was part of the international road map of technologies for semiconductors, known as ITRS or “international technology roadmap for semiconductors”.

A great advantage of nanoimprint lithography is that it permits, just as with the masks or reticles of optical lithography and in contrast to electron-beam lithography, reproducing all the patterns of a device simultaneously from one mold. The mold is used, for example, for imprinting heated thermosetting or thermoplastic monomers or polymers. After cooling, the mold may be removed, while the imprinted patterns remain in place without noteworthy deformations. These patterns may then be transferred by gravure with the same precision into the underlying layer of the device undergoing manufacture. The imprint precision is therefore that of the mold. It may therefore be achieved with a lithography technique such as that mentioned hereinabove with electron beams, thus making it possible to attain the desired resolution of several tens of nanometers. Nanoimprint lithography is therefore a very attractive technique for the entire micro and nanotechnologies industry, since it combines the precision of definition of patterns attainable by means of electron-beam lithography with the production speed of optical lithography using masks or reticles making it possible to reproduce all the patterns of a device undergoing manufacture simultaneously on one plate.

Nevertheless, the production of an imprint mold having high resolution (typically on the order of several tens or hundreds of nanometers) is a long and costly operation and is justified only for substantial industrial production. In addition, when it is desired to modify the design of a mold, the mold must necessarily be reconstructed in its entirety, thus further increasing the cost of devices produced by nanoimprinting.

Consequently, it would be particularly advantageous to propose a solution for reducing the cost associated with the modification of patterns present in a mold. The goal of the present invention is to propose such a solution.

The other objects, characteristics and advantages of the present invention will become apparent upon examination of the description hereinafter and of the accompanying drawings. It is understood that other advantages may be incorporated.

### SUMMARY OF THE INVENTION

The present invention proposes a method for manufacturing a nanoimprint lithography mold, comprising a step of depositing, on a support belonging to the mold, a layer of phase-changing material having a volume variation of at least 2% between a crystalline phase and an amorphous phase, so that a local modification of the phase of the phase-changing material forms a pattern at the surface of the said layer.

Thus patterns may be formed throughout the life of the mold, especially after the first uses of the mold. Consequently the invention permits modification of the patterns of the mold. Thus the mold may be easily reconfigured.

The pattern is capable of being transferred by imprinting into a layer into which the mold comprising the support and the layer of a phase-changing material is pressed.

Optionally and advantageously, the method comprises a step of personalizing the mold, in the course of which relief patterns are formed by making the phase-changing material transition locally from one of the phases to the other phase. Preferably, the personalization step consists in making the layer of phase-changing material transition locally from its crystalline phase to its amorphous phase.

Also optionally, the method comprises, for at least one relief pattern, a step of at least partial erasure of the relief pattern. Thus the method of formation of patterns is reversible. The invention therefore makes it possible to cause patterns to appear or disappear so as to adjust or correct a mold. The invention also makes it possible, starting from a first mold, to manufacture a second mold having patterns different from the first. The cost of obtaining a second mold is therefore limited, since it originates from an existing mold. The invention therefore offers the possibility of using nanoimprint lithography even for short series. It is therefore of considerable interest from an industrial viewpoint.

Furthermore, the method according to the invention involves a limited number of steps for producing the mold.

According to another aspect, the invention relates to a nanoimprint lithography mold comprising a support and a layer topping the support. The layer is formed by a phase-changing material having a volume increase of at least 2% between a crystalline phase and an amorphous phase, the layer being configured so that a local modification of the phase of the phase-changing material forms a pattern on the surface of the said layer.

Optionally, the mold according to the invention may have at least any one of the optional characteristics listed hereinafter.

Preferably the mold comprises patterns formed by the layer of phase-changing material, the phase of the phase-changing material being different at the level of the patterns from the phase of the phase-changing material at the level of those portions of the layer of the phase-changing material that do not form patterns.

Preferably, the layer of phase-changing material has a first face turned toward the support and a second face that is opposite the first face and is covered by a protective layer. Advantageously the protective layer is a layer of dielectric material.

Preferably the mold comprises a heat-regulating layer disposed between the layer of phase-changing material and the support. Advantageously the heat-regulating layer is a layer of dielectric material.

Preferably the mold comprises a metal layer disposed between the layer of phase-changing material and the support and preferably directly in contact with the support.

According to another aspect, the invention relates to a method for modifying a mold such as described in the foregoing, the mold comprising relief patterns formed in the layer of phase-changing material, the method comprising a step of locally modifying the phase of the phase-changing material so that an existing pattern is made to disappear at least partly or so that an existing pattern is extended or so that a new pattern is formed at the surface of the said layer of phase-changing material.

### BRIEF DESCRIPTION OF THE FIGURES

The purposes and objects as well as the characteristics and advantages of the invention will become more apparent from the detailed description of an embodiment thereof illustrated in the following accompanying diagrams, wherein:

FIGS. 1a to 1c describe the principle of obtaining a reconfigurable imprint mold according to an exemplary embodiment of the invention.

FIGS. 2a to 2d illustrate the steps of reconfiguration of the mold according to an exemplary embodiment of the invention.

FIG. 3 indicates examples of phase-changing alloys particularly appropriate for constructing a reconfigurable mold according to the invention.

FIG. 4 shows different structures of reconfigurable molds according to the invention.

FIG. 5 illustrates experimental results in which the relief patterns are created by means of a laser in order to personalize a reconfigurable mold.

FIG. 6 illustrates other experimental results in which the relief patterns of different dimensions and heights are obtained with different adjustments of the writing laser.

FIG. 7 illustrates the operation of erasure of the mold patterns by means of the writing laser.

The attached drawings are given by way of examples and are not limitative of the invention.

The drawings are given by way of examples and are not limitative of the invention. They constitute schematic representations of the principle, for the purpose of facilitating understanding of the invention, and are not necessarily on the scale of practical applications. In particular, the relative thicknesses of the different layers are not representative of reality.

### DETAILED DESCRIPTION OF THE INVENTION

Before a detailed review of embodiments of the invention is begun, the optional characteristics that may be used in association or alternatively will be listed hereinafter:

Preferably the layer of phase-changing material is at least partly in its crystalline phase before the personalization step.

Advantageously the formation of patterns is achieved by local irradiation of the layer of phase-changing material by means of a writing laser.

Preferably the layer of phase-changing material exhibits a volume increase greater than 4% and preferably greater than 5% between its crystalline phase and its amorphous phase.

According to one embodiment, the step of at least partial erasure is applied to all the patterns. Preferably the erasure step is performed in an annealing furnace, which completely restores the layer of phase-changing material to its crystalline phase, thus causing all patterns to disappear.

According to another embodiment, the erasure step is localized. It is performed by means of a laser. Advantageously the laser is the laser used to bring about the formation of patterns.

Advantageously the method comprises a step of depositing an upper layer of a dielectric material. This layer is deposited on the layer of phase-changing material. Preferably the step of depositing an upper layer of dielectric material is performed after the step of depositing the layer of phase-changing material on the support and before the step of personalization of the mold.

Advantageously, the step of depositing a layer of phase-changing material is preceded by a step of depositing a lower layer of dielectric material.

Advantageously the step of depositing a layer of phase-changing material and/or the step of depositing a lower layer of dielectric material is additionally preceded by a step of depositing a metal layer.

If the mold does not comprise a lower layer of a dielectric material between the support and the layer of phase-changing material, then the latter is preferably deposited directly in contact with the support. Otherwise it is preferably directly in contact with the lower layer of dielectric material. The latter is preferably directly in contact with the support or in contact with a metal layer.

If the mold does not comprise an upper layer of a dielectric material, then one face of the layer of phase-changing material is in contact with the ambient medium. If the layer of phase-changing material is covered with an upper layer of a dielectric material, then it is this upper layer of dielectric material that has a face in contact with the ambient medium.

Preferably the phase-changing material is selected from among the binary or ternary chalcogenide alloys. In particular, the alloys comprising two or three elements from among germanium (Ge), tellurium (Te) and antimony (Sb) prove to be particularly advantageous for employment of the invention. The invention also extends to the alloys comprising two or three of these elements as well as other elements.

In a particular embodiment, the mold has a transparency greater than 0%. Thus the mold may be used in a nanoimprint method assisted by a light flux, typically of UV. That makes it possible, for example, to stabilize the resin during pressing of the mold. Advantageously the transparency of the mold is greater than 60%.

According to a particular embodiment, the layer has a transparency at least greater than 40% and preferably at least greater than 60%. Thus the mold may be used to perform a step of nanoimprinting assisted by ultraviolet radiation, or for a method of photolithography combined with nanoimprinting. In a method of this type, the mold is pressed in known manner into a resin and the resin is exposed selectively through the mold.

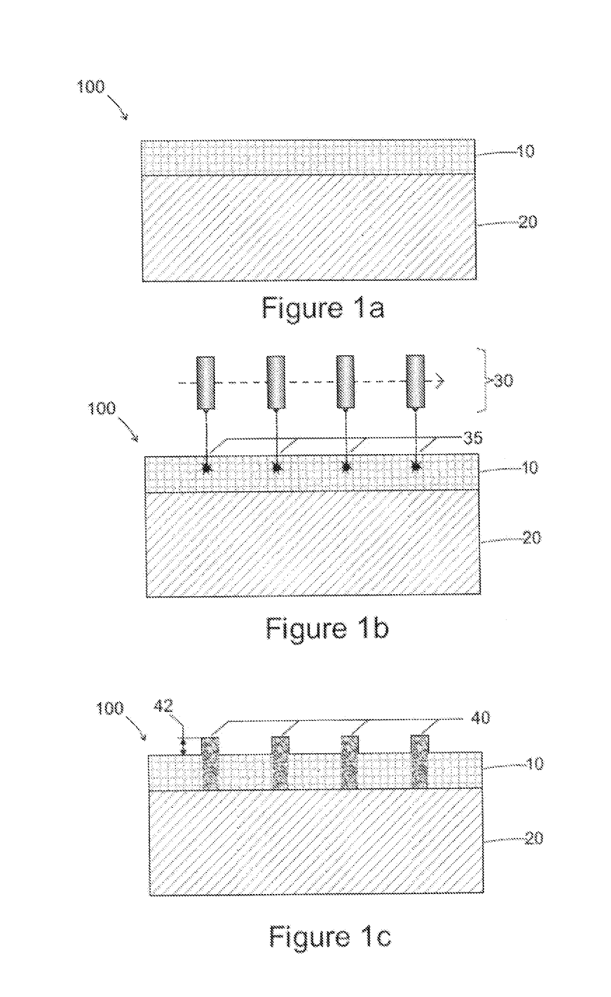

FIGS. 1a, 1b and 1c describe the principle of producing a reconfigurable imprint mold according to the invention.

To produce a reconfigurable mold, the invention uses a type of materials chosen from among those referred to as “phase-changing”. These are most commonly chalcogenide alloys based on tellurium (Te). These materials are currently used in rerecordable optical memories that have the form of compact disks or “CDs” and of digital video disks, known by their acronyms of “DVD” and “Blu-Ray”. They are also used in non-volatile electrical memories of the “PCRAM”, type, the English acronym for “phase change random access memory”, in other words a “phase-changing memory with random access”. The advantage of these materials is that they can be made to change very rapidly, typically in several tens of nanoseconds, between an amorphous state and a crystalline state, in which they exhibit very different properties. In the case of digital video disks, it is the strong contrast of optical reflection between the amorphous phase and the crystalline phase that permits the encoding of information. In the case of electrical memories, it is the great difference of resistance between the two phases that is exploited. The reversibility of the phase transformations may be guaranteed over a very large number of cycles. This number is typically greater than one million cycles.

The optical and electrical properties mentioned hereinabove that are exploited respectively by the digital video disks and the memories of PCRAM type are not the only properties that depend strongly on the state in which the phase-changing material exists. In particular, it has been found that these materials also exhibit strong contrasts of bulk density (ρ) between the two phases, the density of the amorphous phase (ρₐₘₒᵣₚₕₒᵤₛ) being lower than the density of the crystalline phase (ρ_{crystal}). The volume occupied by a given amount of material is therefore larger in the amorphous phase than in the crystalline phase. This behavior is considered to be a serious disadvantage, because it may create, according to the applications and structures in which the material is used, repetitive mechanical stresses in each transformation cycle, with the tendency to limit the lifetime of a device using it. In contrast, the invention takes advantage of this variation of bulk density to produce a reconfigurable imprint mold.

As illustrated in FIGS. 1a to 1c, the invention consists in using an adapted structure of preferably thin layers, which structure, in its simplest form represented in FIG. 1a, includes simply one layer 10 of a phase-changing material. The latter is deposited on a support 20, also known as substrate, which constitutes the mechanical support of a mold 100 according to the present invention. It will be noted that the invention extends to all methods in which support 20 is omitted or is substituted by or partly carried on another support.

It is pointed out that the term “on” within the scope of the present invention does not necessarily mean “in contact with”. Thus, for example, the deposition of a first layer on a second layer does not necessarily mean that the two layers are directly in contact with one another, but instead means that the first layer covers the second layer at least partly by being either directly in contact therewith or by being separated therefrom by another layer or another element.

Initially, layer 10 of phase-changing material is in its crystalline state or is restored to that state after deposition of that layer, for example by heating structure 100 above the crystallization temperature of the phase-changing material constituting it. The reconfigurable mold is then devoid of any pattern.

As shown in FIG. 1b, local heating of layer 10 of this structure, for example by laser irradiation 30, will make it possible to cause the phase-changing material to transition in all irradiated zones 35 to its amorphous disordered phase less dense than the initial crystalline structure.

As illustrated in FIG. 1c, stress relaxation causes a surface topography in the form of reliefs 42 on the order of approximately 50 nm to appear at the level of these zones. Amorphous relief patterns 40 obtained in this way will then be capable of being used for a subsequent nanoimprint lithography operation using structure 100 as imprint mold. The formation of amorphous patterns 40, which corresponds to the step of writing of the reconfigurable mold, is therefore achieved, for example, by means of a laser beam 30, which will be steered by standard mechanical, electronic and software means (not illustrated) in order to successively irradiate all the zones of layer 10 of phase-changing material where relief patterns 40, intended for imprinting, must be formed.

The wavelength and numerical aperture of the focusing objective define the resolution of the optical system and therefore the dimension of the laser spot. The effective diameter of the laser spot determines the lateral dimension of the amorphous pattern, in other words the dimension in a direction parallel to the plane of the surface of layer 10. Each laser spot makes it possible to create a dot of amorphous material having at most the dimension of this spot. The expected diameter of the dot will be a function of the laser power used but will remain smaller in dimension than the size of the laser spot. For example, with an optical system of the type of those used with digital video disks of “Blu-Ray” type, wherein the wavelength λ=405 nm and the numerical aperture ON=0.85, the expected dimensions of the amorphous dots will be smaller than 386 nm, as indicated in the following table.

| | | | Expected diameter | |
|---|---|---|---|---|
| | | Effective diameter | of the amorphous | Available |
| λ | ON | of the laser spot | dots | laser power |
| 650 nm | 0.6 | 870 nm | <870 nm | <40 mW |
| 405 nm | 0.85 | 386 nm | <386 nm | <15 mW |
| 405 nm | 0.75 | 443 nm | <443 nm | <70 mW |

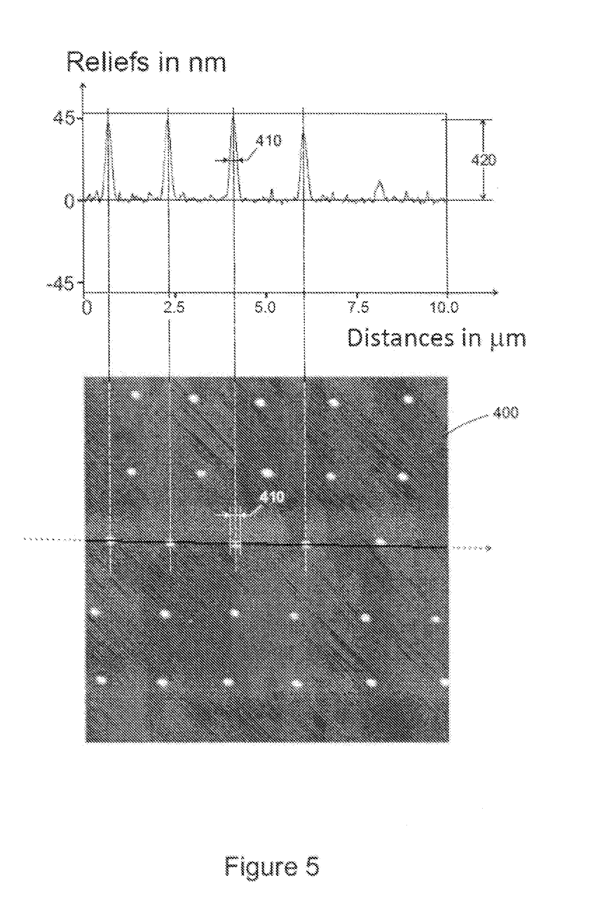

It will be seen hereinafter that it is possible to make the dimension of the amorphous dots vary by modifying the irradiation parameters, in other words the pulse power and duration. As mentioned in the description of FIG. 5, the dots obtained have a diameter on the order of 200 nm. An appropriate modification of the irradiation conditions, consisting in particular of a reduction of the power to approximately 35 mW, makes it possible to obtain dots on the order of 180 nm with the very simple structure illustrated in FIGS. 1a to 1c, comprising a layer of phase-changing material 10 deposited on a substrate 20 of silicon.

An optical structure more complex than that used to obtain the results illustrated in the figures, with heat sinks, for example, as well as the use of a laser having a larger optical resolution (ON=0.85) makes it possible to obtain amorphous dots on the order of 100 nm or even of smaller dimension.

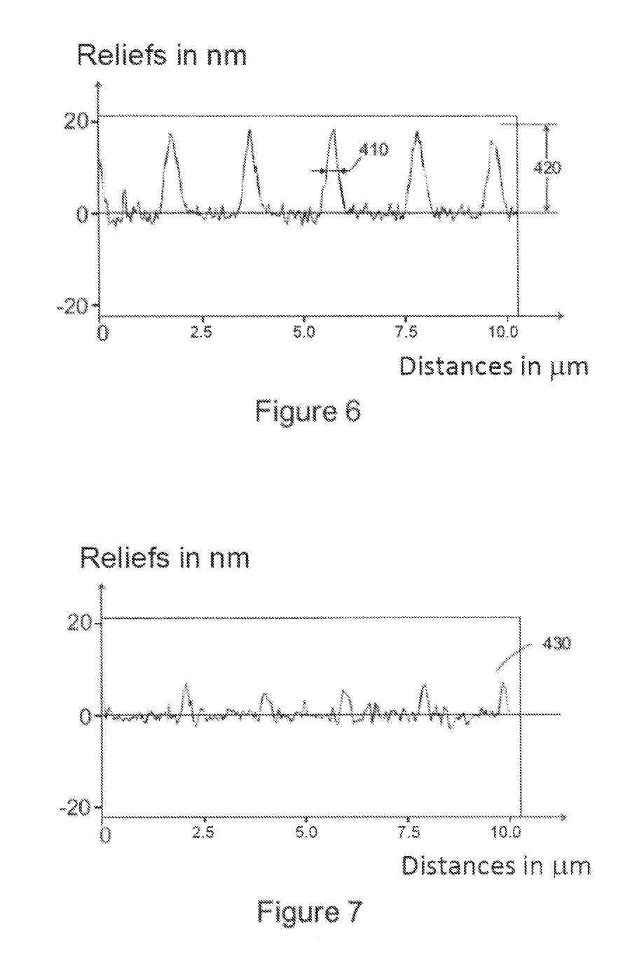

It is also interesting to note that it will be possible to modulate the topography and to obtain relief patterns of heights that vary according to the power used, as will be seen in FIGS. 5 and 6.

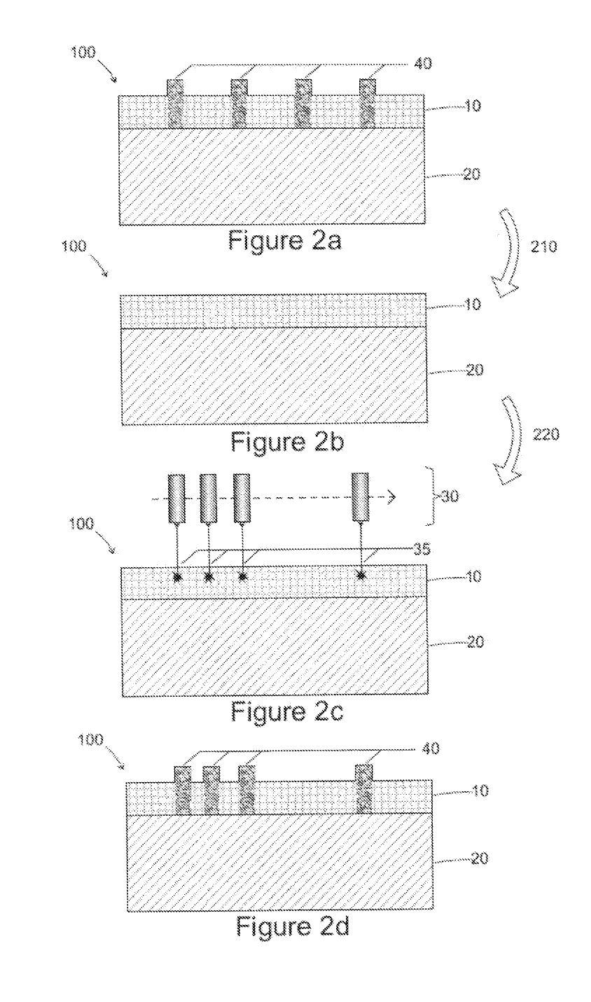

The advantage of using a phase-changing material is that the process of personalization of the mold has become reversible. By heating structure 100 above the crystallization temperature of the phase-changing material in its entirety or locally, it will recrystallize and return to its initial density, thus erasing the surface topography and the patterns that existed there. FIGS. 2a to 2d illustrate the steps of reconfiguring a mold 100 according to the invention. Starting from an existing personalization, for example that of FIG. 2a, a first step 210 leads to erasure thereof. As indicated hereinabove, the erasure, an operation consisting in recrystallizing layer 10, may be performed globally by performing thermal annealing in a standard annealing furnace, which will be heated to a temperature typically between 150 and 200° C. depending on the composition of the phase-changing alloy used for layer 10.

The erasure may also be achieved locally, as may writing. Preferably the same laser and the same steering infrastructure then are used. In this case, the laser is adjusted to deliver a power approximately two times higher than that used for writing, thus permitting successive recrystallization and erasure of each of the amorphous dots. In both cases, the result is that shown in FIG. 2b, where the mold once again is devoid of any pattern.

Nevertheless, it will be noted here that an advantage of the invention is that it is also possible to use the writing laser for only partial erasure of the personalization in the case that only correction of certain patterns 40 must be performed.

It is then possible to proceed to a new personalization of reconfigurable mold 100 under the same conditions as those described in FIGS. 1b and 1c. Since the steering system of laser 30 is loaded with a completely different personalization or with corrections of an existing mold, writing step 220 is performed and consists in irradiating all zones 35 where a relief (40) must be created. At the end of this step, mold 100 is reconfigured as illustrated in FIG. 2d, for example.

It is therefore clearly evident from the foregoing description that finalized mold 100 comprises layer 10 of phase-changing material as well as support 20.

The reversibility or cyclability of transformations between the amorphous and crystalline phases is extremely high for the phase-changing materials under consideration. The optical memories now commercially available attain a durability of 10⁶ cycles, while the specifications for electrical memories potentially require a cyclability of 10¹³ cycles. The lifetime of a reconfigurable mold according to the invention is therefore potentially extremely long and is in no way limited by the number of reconfigurations to which it will be subjected.

It will also be noted that the personalization is achieved by employing methods that are simple and inexpensive compared with lithography and gravure methods used to produce a standard mold. The laser exposure does not necessitate working in a highly controlled atmosphere, such as that of “clean” rooms, where photolithography is carried out. Neither does it necessitate having to create a vacuum to form the smallest patterns, and the laser writing system merely has to pass over the substrate to structure it, without any contact therewith. The laser exposure may be applied to substrates of any size and shape. Similarly, thermal annealing is a simple, low-cost step, which is very easy to employ.

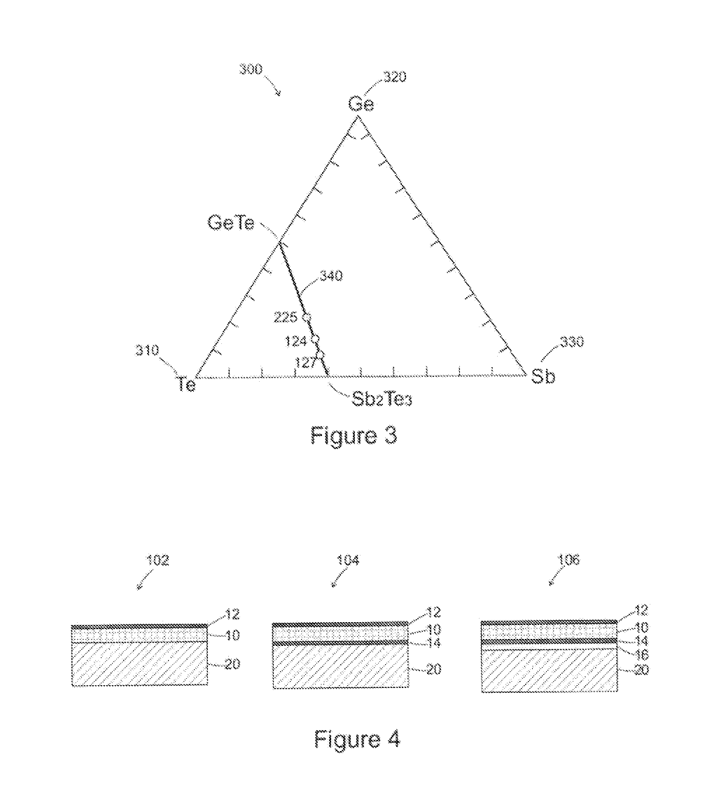

By means of a diagram 300 of ternary alloys based on tellurium (Te), FIG. 3 illustrates the phase-changing materials that are the most appropriate for constituting layer 10 of a reconfigurable mold according to the invention.

The ternary chalcogenide alloys under consideration comprise not only tellurium (Te) 310 but also germanium (Ge) 320 and antimony (Sb) 330. The most suitable alloys, meaning those having the largest volume variation, are preferably chosen along line 340 between the binary alloys GeTe and Sb₂Te₃. In particular, they are Ge₂Sb₂Te₅, referenced 225, Ge₁Sb₂Te₄, referenced 124, and Ge₁Sb₂Te₇, referenced 127. The volume variation of the binary alloy GeTe is the greatest observed. It has also been possible to discover that the materials that have the highest optical contrast are also those exhibiting a large variation of bulk density.

The potentially suitable phase-changing materials must exhibit a volume variation of at least 2% between the crystalline phase and the amorphous phase, preferably greater than 4% and, for example, between 5% and 20%.

It has actually been observed experimentally that a small volume variation of the phase-changing material is sufficient to create reliefs that are proportionally much larger, as will be seen in the following figures. For example, it has been observed that reliefs on the order of 50 nm can be formed on a layer of phase-changing material having a thickness of only 100 nm and a volume variation of the material of only 10% between the crystalline and amorphous states. It has been conjectured that this particular behavior may be explained by the passage of the phase-changing material to the liquid state during the transition between the crystalline and amorphous phases. It is probable, in fact, that the passage of the dots to the liquid state induces the occurrence of phenomena related to fluid mechanics, thus creating mechanisms of destabilization of the liquid surface on the micrometric or nanometric scale. The modeling of such phenomena is known to the person skilled in the art. It requires knowing two properties of the phase-changing material in its liquid state, specifically: its surface energy, which is expressed in joules per square meter (J/m²) and its viscosity, which is expressed in pascal-seconds (Pa·S).

FIG. 4 shows more elaborate structures of reconfigurable molds according to the invention.

Structure 102 includes an upper dielectric layer 12, which is deposited on layer 10 of phase-changing material. Upper dielectric layer 12 is intended to protect the layer of phase-changing material from aging and oxidation. This layer also makes it possible to protect the structure when the phase-changing material is heated to melting during the transitions between the crystalline and amorphous phases, especially by making it possible to limit the amplitude of the deformation related to excessive destabilization of the surface when it transitions through its liquid phase. Substrate 20 is typically made of silicon. Dielectric layer 12 must be able to withstand the volume variations during phase transitions. It is preferably made of a material of fine-grained structure. The use of oxides for this layer, and especially silicon dioxide (SiO₂), is preferred.

Structure 104 includes a dielectric layer on both sides of layer 10 of phase-changing material, and so it also comprises a lower dielectric layer 14. In this embodiment, layer 10 of phase-changing material has a lower face turned toward support 20 and in contact with lower dielectric layer 14. It also has an upper face turned toward the ambient medium and in contact with upper dielectric layer 12.

Additionally, structure 106 also includes a metal layer 16 between substrate 20 and lower dielectric layer 14. This metal layer 16 is preferably directly in contact with lower dielectric layer 14 and support 20. This metal layer 16 may also be disposed directly in contact with layer 10 of phase-changing material in the case in which the mold does not comprise a lower dielectric layer 14.

In these structures, the upper dielectric layer has an optical function in addition to its protective function. Depending on its thickness, it may act to regulate the optical absorption of layer 10 of phase-changing material. As regards lower dielectric layer 14, which is situated between the silicon of the substrate and the phase-changing material in structure 104; or between metal layer 16 and layer 10 in structure 106, its function is mainly thermal. It makes it possible to regulate heat exchanges between the layer of phase-changing material and the silicon or the metal heat sink. The silicon and the metal layer, having very good thermal conductivity, make it possible to evacuate the heat very rapidly at the end of the laser pulse and permit the formation of the amorphous phase.

The metal of layer 16 may be chosen from among the following list: aluminum (Al), silver (Ag), copper (Cu), nickel (Ni), zinc (Zn), chromium (Cr), tungsten (W), tantalum (Ta), titanium (Ti), platinum (Pt), palladium (Pd), gold (Au) and all the alloys thereof. The dielectric of lower layer 14 may be chosen from among all the oxides, nitrides or oxynitrides of the metal elements cited hereinabove as well as among all the oxides, nitrides and oxynitrides of semiconductor elements belonging to group IV of the periodic table of elements, in particular containing silicon (Si) and germanium (Ge).

In structures 100, 102, 104 and 106, the thickness of layer 10 of phase-changing material is typically between 20 and 300 nm and preferably between 50 and 150 nm. That of the dielectric layers is between 2 and 100 nm and preferably between 5 and 50 nm. Metal layer 16 is greater than or equal to 200 nm and preferably greater than or equal to 100 nm.

FIG. 5 illustrates experimental results observed with a structure of type 106 as shown in FIG. 4. More precisely, the structure is that described below:

Substrate 20 is made of silicon.

Metal layer 16 is constituted of tungsten (W) with a thickness of 100 nm.

Lower dielectric layer 14 is made of silicon dioxide (SiO₂) with a thickness of 20 nm.

The layer of phase-changing material 10 is constituted of the binary alloy GeTe on a thickness of 100 nm.

Upper dielectric layer 12 is also made of silicon dioxide (SiO₂). It has a thickness of 20 nm.

The thin layers are obtained by physical vapor-phase deposition or PVD, the English acronym for “physical vapor deposition”.

Structure 106 is subjected to preliminary thermal annealing of 1 hour at 200° C. in order to crystallize the GeTe layer forming layer 10 of phase-changing material. This is actually amorphous at the end of PVD.

An array of dots 400 is then formed on the surface of structure 106 by means of laser pulses of controlled power and duration, in other words, in the experimental situation illustrated in FIG. 5: Pₗₐₛₑᵣ=45 mW, pulse duration tₚᵤₗₛₑ=65 ns. The laser is a blue laser of wavelength λ=405 nm and numerical aperture ON=0.75.

The measurements are made using an atomic force microscope or AFM, the English acronym for “atomic force microscope”. The diameter of dots 410 is on the order of 200 nm, with a mean height 420 of 45 nm.

FIG. 6 shows that, with a structure of type 106, identical to the preceding in all points, it is possible to modify the dimension and height of the amorphous dots at the same time. In this case the writing conditions are: Pₗₐₛₑᵣ=70 mW, pulse duration tₚᵤₗₛₑ=120 ns. Dots having larger diameter 410 on the order of 350 nm but of lower height 420 of approximately 20 nm are then obtained.

FIG. 7 illustrates the reversibility of the process of amorphization of dots by means of the writing laser. The foregoing array of dots, that obtained with the conditions of FIG. 6, is then recrystallized by means of laser pulses of lower power: Pₗₐₛₑᵣ=30 mW and of longer duration: tₚᵤₗₛₑ=200 ns. These laser pulses are applied to each of the amorphous dots created previously. A new observation 430 by means of the atomic force microscope shows that the amorphous dots have then almost disappeared. The material has therefore been thoroughly recrystallized and the surface topography has practically become plane once again, in other words it is again that of the initial crystalline matrix. It will be noted that the residual reliefs that can nevertheless be observed in this particular experimental situation may be further improved by adjustment of the laser power for recrystallization and by more precise control of the shifts between the spots for recrystallization and those that initially created the amorphous dots.

The present invention is not limited to the embodiments described in the foregoing but extends to any embodiment in conformity with its spirit.

1. A method for manufacturing a nanoimprint lithography mold (100), the method being characterized in that it comprises a step of depositing, on a support (20) of the mold (100), a layer (10) of phase-changing material having a volume variation of at least 2% between a crystalline phase and an amorphous phase, so that a local modification of the phase of the phase-changing material forms a pattern (40) at the surface of the said layer (10) belonging to the mold (100), the method also being characterized in that it comprises a step of personalization (220) of the mold (100), in the course of which relief patterns (40) are formed by making the layer (10) of phase-changing material transition locally from one of the phases to the other phase.

2. A method according to claim 1, wherein the personalization step (220) consists in making the layer (10) of phase-changing material transition locally from its crystalline phase to its amorphous phase.

3. A method according to claim 1, wherein the layer (10) of phase-changing material is at least partly in its crystalline phase before the personalization step (220).

4. A method according to claim 1, wherein the formation of patterns (40) is achieved by local irradiation (30) of the layer (10) of phase-changing material by means of a writing laser.

5. A method according to claim 1, wherein the layer (10) of phase-changing material exhibits a volume increase greater than 4% between its crystalline phase and its amorphous phase.

6. A method according to claim 1 comprising, for at least one relief pattern (40), a step of at least partial erasure (210) of the relief pattern (40).

7. A method according to claim 6, wherein the step of at least partial erasure (210) is applied to all the patterns (40).

8. A method according to claim 7, wherein the erasure step (210) is performed in an annealing furnace, which completely restores the layer (10) of phase-changing material to its crystalline phase, thus causing all patterns (40) to disappear.

9. A method according to claim 6, wherein the erasure step is performed on certain patterns only and by means of a laser.

10. A method according to claim 4 comprising, for at least one relief pattern (40), a step of at least partial erasure (210) of the relief pattern (40), the erasure step being performed by means of the laser used to achieve the formation of patterns (40).

11. A method according to claim 1 comprising a step of depositing an upper layer (12) of a dielectric material on the layer (10) of phase-changing material.

12. A method according to claim 11, wherein the step of depositing an upper layer (12) of dielectric material is performed after the step of depositing the layer (10) of phase-changing material on the support (20) and before the step of personalization (220) of the mold.

13. A method according to claim 1, wherein the step of depositing a layer (10) of phase-changing material is preceded by a step of depositing a lower layer (14) of dielectric material.

14. A method according to claim 13, wherein the step of depositing a layer (10) of phase-changing material and/or the step of depositing a lower layer (14) of dielectric material is additionally preceded by a step of depositing a metal layer (16).

15. A method according to claim 1, wherein the phase-changing material is selected from among the binary or ternary chalcogenide alloys.

16. A nanoimprint lithography mold (100, 102, 104, 106) comprising a support (20) and a layer (10) topping the support (20); characterized in that the layer (10) is formed by a phase-changing material having a volume increase of at least 2% between a crystalline phase and an amorphous phase and is configured so that a local modification of the phase of the phase-changing material forms a pattern (40) on the surface of the said layer (10); and in that the mold (100, 102, 104, 106) comprises patterns (40) formed by the layer (10) of phase-changing material, the phase of the phase-changing material being different at the level of the patterns (40) from the phase of the phase-changing material at the level of those portions of the layer (10) of the phase-changing material that do not form patterns (40).

17. A mold (102, 104, 106) according to claim 16, wherein the layer (10) of phase-changing material has a first face turned toward the support (20) and a second face that is opposite the first face and is covered by a protective layer.

18. A mold (102, 104, 106) according to claim 17, wherein the protective layer is preferably a layer (12) of dielectric material.

19. A mold (104, 106) according to claim 16, comprising a heat-regulating layer disposed between the layer (10) of phase-changing material and the support (20).

20. A mold (104, 106) according to claim 19, wherein the heat-regulating layer is preferably a layer (14) of dielectric material.

21. A mold (106) according to claim 16 comprising a metal layer (16) disposed between the layer (10) of phase-changing material and the support (20).

22. A mold (100, 102, 104, 106) according to the preceding claim 16, having a transparency at least greater than 40%.

23. A method for modifying a mold (100) according to claim 16, claim 17 or claim 19, the mold comprising relief patterns (40) formed in the layer (10) of phase-changing material, the method comprising a step of locally modifying the phase of the phase-changing material so that an existing pattern (40) is made to disappear at least partly or so that an existing pattern (40) is extended or so that a new pattern (40) is formed at the surface of the said layer (10) of phase-changing material.
